(19) United States
(12) Patent Application Publication
(10) Pub. No.: US 2020/0089017 A1
(43) Pub. Date: Mar. 19, 2020

(54) HEAD-MOUNTED DISPLAY AND OPTICAL DEVICE THEREOF

(71) Applicant: Quantum Optoelectronics Inc., Taipei City (TW)

(72) Inventors: SHIH-PING WU, Taipei City (TW); CHI-WEI CHEN, Taipei City (TW); YU-SHENG LIU, Taipei City (TW); MING-HSIEN TSAI, Taipei City (TW)

(21) Appl. No.: 16/176,066

(22) Filed: Oct. 31, 2018

(30) Foreign Application Priority Data
Sep. 14, 2018 (TW) 107132493

(51) Int. Cl. G02B 27/28; G02B 5/30

(52) U.S. Cl. CPC G02B 27/283; G02B 5/3083

(57) ABSTRACT

A head-mounted display and an optical device are provided. The head-mounted display includes a display element, the optical device and an optical lens. Along an optical axis of the head-mounted display, the optical device includes a polarization beam splitter, a first phase retarder, a beam splitting element and a second phase retarder sequentially. The optical device receives plural light beams from the display element. The optical device is capable of travelling the light beams back and forth many times. The distance between the display element of the head-mounted display and the human eyes is shortened. Consequently, thus the volume of the head-mounted display is reduced.

### FIELD OF THE INVENTION

The present invention relates to the field of an optical technology, and more particularly to an optical device and a display device.

### BACKGROUND OF THE INVENTION

With the rapid development of science and technology, people's demands on the multimedia video are gradually increasing. Generally, the multimedia playback device is equipped with a LCD display device or a LED display device to show the images. The pixels and sizes of the images to be shown on the display device are restricted by the size and performance of the display device. In addition, the visual effect is limited. A long-term use of the display device may cause fatigue of the eyes.

Recently, a head-mounted display (HMD) has been introduced into the market. The head-mounted display is an optical product for generating a stereoscopic displaying effect. A signal representing a stereoscopic effect of binocular parallax is transmitted to the two eyes of the user through a display unit in front of the two eyes and an optical lens sequentially. Consequently, a stereoscopic and large-sized image is generated. The head-mounted display is usually applied to an augmented reality (AR) system and a virtual reality (VR) system. The head-mounted display can be moved with the user. In addition, the head-mounted display can be used as an input device to receive the response actions of the user. Moreover, pictures and texts can be added to the images that are viewed by the user. Consequently, the augmented reality efficacy or the virtual reality efficacy is achieved.

In the existing head-mounted display, the display element and the human eyes have to be separated from each other by a specified distance according to the specification of a field of view (FOV) and an equivalent focal length of the optical lens. Consequently, the light beams from the display element can be effectively guided to the human eyes. Generally, the specified distance is at least 50 mm. Consequently, it is difficult to minimize the head-mounted display. For solving the above drawbacks, the optical lens is arranged between the display element and the human eyes, and reflection films are coated on other optical elements and/or the optical lens to shorten the required distance between the display element and the human eyes. For example, associated technologies were disclosed in Chinese Patent No. CN105093555B, US Patent Application No. 20060232862, U.S. Pat. Nos. 5,715,023 and 5,966,242.

However, the above patents still has some drawbacks. Firstly, the optical elements such as a cholesteric liquid crystal display (CLCD) used in the above patents have low polarization efficiency. Secondly, after the light beams from the display element pass through the plural optical elements and the optical lens, only small portions of the light beams reach the human eyes. In other words, the light utilization efficiency is low. Thirdly, the optical structure and the optical path design are only suitable for a specified head-mounted display. Since the optical structure and the optical path design of the head-mounted display are not suitable for another head-mounted display, the volume of another head-mounted display cannot be further reduced.

In other words, the existing head-mounted display needs to be further improved.

### SUMMARY OF THE INVENTION

For solving the drawbacks of the conventional technologies, the present invention provides an optical device for travelling the light beams back and forth many times. When the optical device is applied to a head-mounted display, the distance between a display element and the human eyes is shortened and the polarization efficiency and the light utilization efficiency are enhanced.

For solving the drawbacks of the conventional technologies, the present invention provides a head-mounted display with the optical device in order to effectively reduce the volume and meet the miniaturization requirement.

In accordance with an aspect of the present invention, there is provided an optical device for a head-mounted display. The head-mounted display includes a display element and an optical lens. The optical device receives plural light beams from the display element. Along an optical axis of the head-mounted display, the optical device includes a polarization beam splitter, a first phase retarder, a beam splitting element and a second phase retarder. The light beams in a first polarization state are transmitted through the polarization beam splitter. The light beams in a second polarization state are reflected by the polarization beam splitter. After the light beams are transmitted through the first phase retarder, a polarization state of the light beams is rotated at a first angle in a first direction with respect to an optical axis of the polarization beam splitter. After the light beams are projected to the beam splitting element, first portions of the light beams are transmitted through the beam splitting element and second portions of the light beams are reflected by the beam splitting element. After the light beams are transmitted through the second phase retarder, the light beams are converted into the light beams in the first polarization state or the light beams in the second polarization state.

In an embodiment, after the light beams are transmitted through the second phase retarder, the polarization state of the light beams is rotated at a second angle in a second direction with respect to the optical axis of the polarization beam splitter, so that the light beams transmitted through the second phase retarder are converted into the light beams in the first polarization state or the light beams in the second polarization state. The second direction is opposed to the first direction. The second angle is substantially equal to the first angle.

In an embodiment, the optical device further includes a filtering element. The light beams in the first polarization state and from the second phase retarder are blocked by the filtering element.

In an embodiment, the filtering element and the polarization beam splitter are axially orthogonal to each other.

In an embodiment, after the light beams are transmitted through the second phase retarder, the polarization state of the light beams is rotated at the first angle in the first direction with respect to the optical axis of the polarization beam splitter, so that the light beams transmitted through the second phase retarder are converted into the light beams in the first polarization state or the light beams in the second polarization state.

In an embodiment, the optical device further includes a filtering element. The light beams in the second polarization state and from the second phase retarder are blocked by the filtering element.

In an embodiment, the filtering element and the polarization beam splitter have the same axial direction.

In an embodiment, the optical device further includes a light-transmissible carrier between the display element and the polarization beam splitter. The polarization beam splitter and the first phase retarder are thin film layers. The light-transmissible carrier, the polarization beam splitter and the first phase retarder are combined as a first stack structure.

In an embodiment, the optical device further includes a filtering element. The light beams transmitted through the second phase retarder are projected to and filtered by the filtering element.

In an embodiment, the second phase retarder and the filtering element are thin film layers, and the beam splitting element, the second phase retarder and the filtering element are combined as a second stack structure.

In an embodiment, the filtering element is a polarizer.

In an embodiment, the optical lens is arranged between the second phase retarder and human eyes, or the optical lens is arranged between the first phase retarder and the beam splitting element.

In an embodiment, the optical lens is a Fresnel lens, a biconvex lens, a plano-convex lens, a concave-convex lens, a biconcave lens, a plano-concave lens or a convex-concave lens.

In an embodiment, there is a spacing distance between the first phase retarder and the beam splitting element, and the spacing distance is related to an equivalent focal length of the optical lens.

If the optical lens is arranged between the second phase retarder and the human eyes, the optical device satisfies at least one of following conditions: (1) 15 mm≤D1≤25 mm, (2) 25 mm≤EFL≤45 mm and (3) 8.5 mm≤D2≤16.5 mm, wherein D1 is a total length of the optical device and the optical lens, EFL is an effective focal length of the optical lens, and D2 is a spacing distance between the first phase retarder and the beam splitting element.

In an embodiment, the light beams in the first polarization state are S-polarized light beams and the light beams in the second polarization state are P-polarized light beams. Alternatively, the light beams in the first polarization state are P-polarized light beams and the light beams in the second polarization state are S-polarized light beams.

In an embodiment, the first angle is 45±15 degrees.

In an embodiment, the polarization beam splitter is a dual brightness enhancement film or a reflective polarizer, or the first phase retarder is a quarter-wave plate, or the second phase retarder is a quarter-wave plate, or the reflectivity of the beam splitting element is in a range between 30% and 60%.

In accordance with another aspect of the present invention, there is provided a head-mounted display. The head-mounted display includes a display element, an optical device and an optical lens. The optical device receives plural light beams from the display element. Along an optical axis of the head-mounted display, the optical device includes a polarization beam splitter, a first phase retarder, a beam splitting element and a second phase retarder. The light beams in a first polarization state are transmitted through the polarization beam splitter. The light beams in a second polarization state are reflected by the polarization beam splitter. After the light beams are transmitted through the first phase retarder, a polarization state of the light beams is rotated at a first angle in a first direction with respect to an optical axis of the polarization beam splitter. After the light beams are projected to the beam splitting element, first portions of the light beams are transmitted through the beam splitting element and second portions of the light beams are reflected by the beam splitting element. After the light beams are transmitted through the second phase retarder, the light beams are converted into the light beams in the first polarization state or the light beams in the second polarization state. The optical lens is arranged between the second phase retarder and human eyes, or arranged between the first phase retarder and the beam splitting element.

In an embodiment, after the light beams are transmitted through the second phase retarder, the polarization state of the light beams is rotated at a second angle in a second direction with respect to the optical axis of the polarization beam splitter, so that the light beams transmitted through the second phase retarder are converted into the light beams in the first polarization state or the light beams in the second polarization state. The second direction is opposed to the first direction. The second angle is substantially equal to the first angle.

In an embodiment, the optical device further includes a filtering element. The light beams in the first polarization state and from the second phase retarder are blocked by the filtering element.

In an embodiment, the filtering element and the polarization beam splitter are axially orthogonal to each other.

In an embodiment, after the light beams are transmitted through the second phase retarder, the polarization state of the light beams is rotated at the first angle in the first direction with respect to the optical axis of the polarization beam splitter, so that the light beams transmitted through the second phase retarder are converted into the light beams in the first polarization state or the light beams in the second polarization state.

In an embodiment, the optical device further includes a filtering element. The light beams in the second polarization state and from the second phase retarder are blocked by the filtering element.

In an embodiment, the filtering element and the polarization beam splitter have the same axial direction.

In an embodiment, the optical device further includes a light-transmissible carrier between the display element and the polarization beam splitter. The polarization beam splitter and the first phase retarder are thin film layers. The light-transmissible carrier, the polarization beam splitter and the first phase retarder are combined as a first stack structure.

In an embodiment, the optical device further includes a filtering element. The light beams transmitted through the second phase retarder are projected to and filtered by the filtering element.

In an embodiment, the second phase retarder and the filtering element are thin film layers, and the beam splitting element, the second phase retarder and the filtering element are combined as a second stack structure.

In an embodiment, the filtering element is a polarizer.

In an embodiment, there is a spacing distance between the first phase retarder and the beam splitting element, and the spacing distance is related to an equivalent focal length of the optical lens.

If the optical lens is arranged between the second phase retarder and the human eyes, the optical device satisfies at least one of following conditions: (1) 15 mm≤D1≤25 mm, (2) 25 mm≤EFL≤45 mm and (3) 8.5 mm≤D2≤16.5 mm, wherein D1 is a total length of the optical device and the optical lens, EFL is an effective focal length of the optical lens, and D2 is a spacing distance between the first phase retarder and the beam splitting element.

In an embodiment, the light beams in the first polarization state are S-polarized light beams and the light beams in the second polarization state are P-polarized light beams. Alternatively, the light beams in the first polarization state are P-polarized light beams and the light beams in the second polarization state are S-polarized light beams.

In an embodiment, the first angle is 45±15 degrees.

In an embodiment, the polarization beam splitter is a dual brightness enhancement film or a reflective polarizer, or the first phase retarder is a quarter-wave plate, or the second phase retarder is a quarter-wave plate, or the reflectivity of the beam splitting element is in a range between 30% and 60%, or the optical lens is a Fresnel lens, a biconvex lens, a plano-convex lens, a concave-convex lens, a biconcave lens, a plano-concave lens or a convex-concave lens.

From the above descriptions, the optical device is capable of travelling the light beams back and forth. When the optical device is applied to the head-mounted display, the distance between the display element and the human eyes is shortened and thus the volume of the head-mounted display is reduced. Moreover, the optical device can increase the polarization efficiency and the light utilization efficiency. Moreover, the optical device of the present invention can be directly installed in the existing head-mounted display so as to reduce the volume of the existing head-mounted display.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A schematically illustrates the architecture of a head-mounted display and an optical device according to a first embodiment of the present invention;

FIG. 1B schematically illustrates the optical paths of the head-mounted display and the optical device as shown in FIG. 1A;

FIG. 2A schematically illustrates the architecture of a head-mounted display and an optical device according to a second embodiment of the present invention;

FIG. 2B schematically illustrates the optical paths of the head-mounted display and the optical device as shown in FIG. 2A;

FIG. 3A schematically illustrates the architecture of a head-mounted display and an optical device according to a third embodiment of the present invention;

FIG. 3B schematically illustrates the optical paths of the head-mounted display and the optical device as shown in FIG. 3A;

FIG. 4A schematically illustrates the architecture of a head-mounted display and an optical device according to a fourth embodiment of the present invention;

FIG. 4B schematically illustrates the optical paths of the head-mounted display and the optical device as shown in FIG. 4A;

FIG. 5 schematically illustrates the architecture of a head-mounted display and an optical device according to a fifth embodiment of the present invention; and

FIG. 6 schematically illustrates the architecture of a head-mounted display and an optical device according to a sixth embodiment of the present invention.

### DETAILED DESCRIPTION OF THE PREFERRED EMBODIMENT

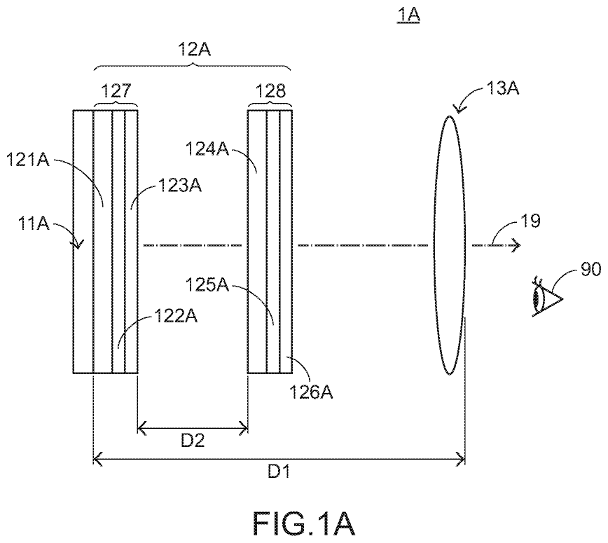

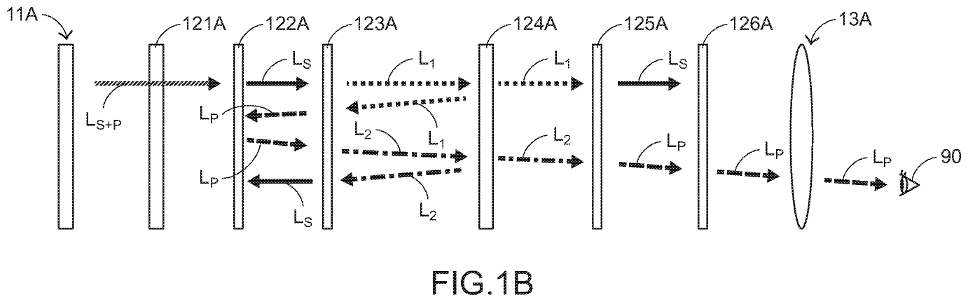

FIG. 1A schematically illustrates the architecture of a head-mounted display and an optical device according to a first embodiment of the present invention. The head-mounted display 1A comprises a display element 11A, an optical device 12A and an optical lens 13A. The optical device 12A is arranged between the display element 11A and the optical lens 13A. The image shown on the display element 11A is projected onto the human eyes 90 through the optical device 12A and the optical lens 13A. The optical device 12A comprises a light-transmissible carrier 121A, a polarization beam splitter 122A, a first phase retarder 123A, a beam splitting element 124A, a second phase retarder 125A and a filtering element 126A along an optical axis 19 of the head-mounted display 1A sequentially.

The light beams in a first polarization state are allowed to pass through the polarization beam splitter 122A. The light beams in a second polarization state are reflected by the polarization beam splitter 122A. After the light beams are transmitted through the first phase retarder 123A, the polarization state of the light beams is rotated at a first angle in a first direction with respect to an optical axis of the polarization beam splitter 122A. Preferably but not exclusively, the first angle is 45±15 degrees.

After the light beams are projected to the beam splitting element 124A, first portions of the light beams are transmitted through the beam splitting element 124A and second portions of the light beams are reflected by the beam splitting element 124A. After the light beams are transmitted through the second phase retarder 125A, the polarization state of the light beams is rotated at a second angle in a second direction with respect to the optical axis of the polarization beam splitter 122A. The second direction is opposed to the first direction. The second angle is substantially equal to the first angle. Preferably but not exclusively, the reflectivity of the beam splitting element 124A is in the range between 30% and 60%. In addition, the light beams transmitted through the second phase retarder 125A is projected to and filtered by the filtering element 126A.

There is a spacing distance D2 between the first phase retarder 123A and the beam splitting element 124A. The spacing distance D2 is related to the equivalent focal length (EFL) of the optical lens 13A. That is, the spacing distance D2 is determined according to the equivalent focal length of the optical lens 13A, or the equivalent focal length of the optical lens 13A is determined according to the spacing distance D2.

In an embodiment, the light-transmissible carrier 121A is a glass plate that is arranged between the display element 11A and the polarization beam splitter 122A. The polarization beam splitter 122A is a dual brightness enhancement film (DBEF). The first phase retarder 123A is a quarter-wave plate. The polarization beam splitter 122A and the first phase retarder 123A are thin film layers. The light-transmissible carrier 121A, the polarization beam splitter 122A and the first phase retarder 123A are stacked on each other and formed as a first stack structure 127. That is, the light-transmissible carrier 121A has the function of supporting the polarization beam splitter 122A and the first phase retarder 123A. In an embodiment, the reflectivity of the beam splitting element 124A is 50%. An example of the filtering element 126A is a polarizer. Moreover, the filtering element 126A and the polarization beam splitter 122A are axially orthogonal to each other. The second phase retarder 125A and the filtering element 126A are also thin film layers. The beam splitting element 124A, the second phase retarder 125A and the filtering element 126A are stacked on each other and formed as a second stack structure 128.

In an embodiment, the light beams in the first polarization state are S-polarized light beams, and the light beams in the second polarization state are P-polarized light beams. That is, only the S-polarized light beams are allowed to pass through the polarization beam splitter 122A, and the P-polarized light beams are reflected by the polarization beam splitter 122A.

FIG. 1B schematically illustrates the optical paths of the head-mounted display and the optical device as shown in FIG. 1A. For clarification, different kinds of light beams as shown in FIG. 1B are indicated by different arrows. In FIG. 1B, L_{S+P} denotes the light beams from the display element 11A, L_{S} denotes the light beams in the first polarization state, L_{P} denotes the light beams in the second polarization state, L₁ denotes the light beams in the changed polarization state, and L₂ denotes the light beams in the changed polarization state. When an image is shown on the display element 11A, the optical device 12A receives the light beams L_{S+P} from the display element 11A. In addition, after the light beams L_{S+P} are transmitted through the light-transmissible carrier 121A, the light beams L_{S+P} are projected to the polarization beam splitter 122A. The light beams L_{S} in the first polarization state are directly transmitted through the polarization beam splitter 122A. The light beams L_{P} in the second polarization state are reflected by the polarization beam splitter 122A.

Then, the light beams L_{S} are projected to the first phase retarder 123A. After the light beams L_{S} are transmitted through the first phase retarder 123A, the light beams L_{S} are converted into the light beams L₁ in the changed polarization state. Then, the light beams L₁ are projected to the beam splitting element 124A. When the light beams L₁ are projected to the beam splitting element 124A, 50% of the light beams L₁ are transmitted through the beam splitting element 124A and 50% of the light beams L₁ are reflected by the beam splitting element 124A. The portions of the light beams L₁ transmitted through the beam splitting element 124A are projected to the second phase retarder 125A. After the portions of the light beams L₁ are transmitted through the second phase retarder 125A, the polarization state is changed and thus the light beams L₁ are converted into the light beams L_{S} in the first polarization state. Then, the light beams L_{S} are projected to the filtering element 126A.

The portions of the light beams L₁ reflected by the beam splitting element 124A are returned back to the first phase retarder 123A. After the portions of the light beams L₁ are transmitted through the first phase retarder 123A, the polarization state is changed and thus the light beams L₁ are converted into the light beams L_{P} in the second polarization state. The light beams L_{P} are returned back to the polarization beam splitter 122A and reflected by the polarization beam splitter 122A. Then, the light beams L_{P} are projected to the first phase retarder 123A. After the light beams L_{P} are transmitted through the first phase retarder 123A, the light beams L_{P} are converted into the light beams L₂ in the changed polarization state. Then, the light beams L₂ are projected to the beam splitting element 124A. When the light beams L₂ are projected to the beam splitting element 124A, 50% of the light beams L₂ are transmitted through the beam splitting element 124A and 50% of the light beams L₂ are reflected by the beam splitting element 124A. The portions of the light beams L₂ transmitted through the beam splitting element 124A are projected to the second phase retarder 125A. After the portions of the light beams L₂ are transmitted through the second phase retarder 125A, the polarization state is changed and thus the light beams L₂ are converted into the light beams L_{P} in the second polarization state. Then, the light beams L_{P} are projected to the filtering element 126A.

As mentioned above, the filtering element 126A and the polarization beam splitter 122A are axially orthogonal to each other. Consequently, when the light beams L_{S} in the first polarization state and the light beams L_{P} in the second polarization state are projected to the filtering element 126A, the light beams L_{S} in the first polarization state are blocked by the filtering element 126A. That is, only the light beams L_{P} in the second polarization state are allowed to pass through the filtering element 126A. After the light beams L_{P} are transmitted through the optical lens 13A, the light beams L_{P} are projected to the human eyes 90.

Preferably but not exclusively, the optical device 12A satisfies at least one of the following conditions: (1) 15 mm≤D1≤25 mm, (2) 25 mm≤EFL≤45 mm and (3) 8.5 mm≤D2≤16.5 mm, wherein D1 is the total length of the optical device 12A and the optical lens 13A, EFL is an effective focal length of the optical lens 13A, and D2 is the spacing distance between the first phase retarder 123A and the beam splitting element 124A.

Preferably but not exclusively, the optical lens 13A is a Fresnel lens. The use of the Fresnel lens as the optical lens 13A has benefits. Since the surface of the Fresnel lens closer to the filtering element 126A is flat, the Fresnel lens and the filtering element 126A can be combined together more easily and thus the volume of the assembled product is smaller. It is noted that the examples of the optical lens 13A are not restricted. The example of the optical lens 13A may be varied according to the required effective focal length or other optical requirements. For example, the optical lens 13A is selected from one of a biconvex lens, a plano-convex lens, a concave-convex lens, a biconcave lens, a plano-concave lens and a convex-concave lens.

From the above descriptions, the head-mounted display 1A is equipped with the optical device 12A between the display element 11A and the optical lens 13A. Due to the optical device 12A, the light beams are allowed to travel back and forth many times. Consequently, the spacing distance between the display element 11A and the human eyes 90 is shortened to be smaller than 30 mm. The reduction of the spacing distance between the display element 11A and the human eyes 90 is helpful to the miniaturization of the head-mounted display 1A. Moreover, due to the optical structure and the optical path design of the optical device 12A, the polarization efficiency and the light utilization efficiency of the head-mounted display 1A are enhanced.

Moreover, the optical device 12A of the present invention can be directly installed in the existing head-mounted display. According to the effective focal length of the original optical lens, the spacing distance D2 between the first phase retarder 123A and the beam splitting element 124A is adjusted. Consequently, even if the specification of the field of view (FOV) of the existing head-mounted display and the equivalent focal length of the optical lens are unchanged, the distance between the display element and the human eyes is shortened. Consequently, the volume of the existing head-mounted display is reduced.

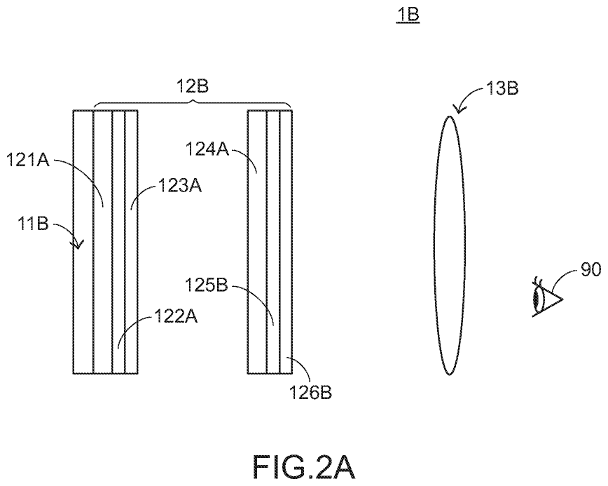

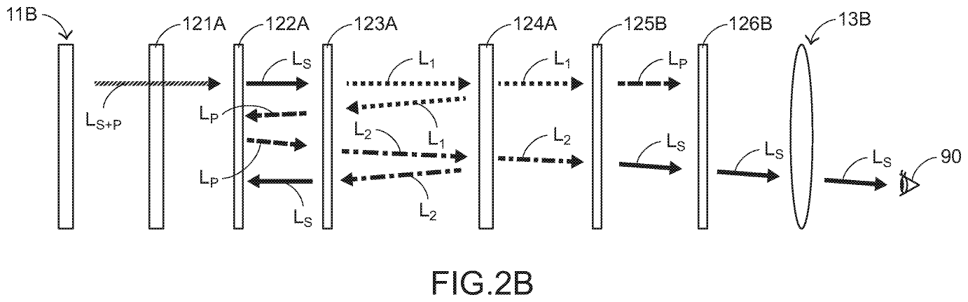

FIG. 2A schematically illustrates the architecture of a head-mounted display and an optical device according to a second embodiment of the present invention. The head-mounted display 1B comprises a display element 11B, an optical device 12B and an optical lens 13B. The optical device 12B comprises a light-transmissible carrier 121A, a polarization beam splitter 122A, a first phase retarder 123A, a beam splitting element 124A, a second phase retarder 125B and a filtering element 126B. The components of the head-mounted display 1B and the optical device 12B which are identical to those of the first embodiment are not redundantly described herein. In comparison with the first embodiment, the operation of the second phase retarder 125B is identical to the operation of the first phase retarder 123A. That is, after the light beams are transmitted through the second phase retarder 125B, the polarization state of the light beams is rotated at the first angle in the first direction with respect to the optical axis of the polarization beam splitter 122A. Moreover, the filtering element 126B and the polarization beam splitter 122A have the same axial direction.

FIG. 2B schematically illustrates the optical paths of the head-mounted display and the optical device as shown in FIG. 2A. For clarification, different kinds of light beams as shown in FIG. 2B are indicated by different arrows. In FIG. 2B, L_{S+P} denotes the light beams from the display element 11B, L_{S} denotes the light beams in the first polarization state, L_{P} denotes the light beams in the second polarization state, L₁ denotes the light beams in the changed polarization state, and L₂ denotes the light beams in the changed polarization state. When an image is shown on the display element 11B, the optical device 12B receives the light beams L_{S+P} from the display element 11B. In addition, after the light beams L_{S+P} are transmitted through the light-transmissible carrier 121A, the light beams L_{S+P} are projected to the polarization beam splitter 122A. The light beams L_{S} in the first polarization state are directly transmitted through the polarization beam splitter 122A. The light beams L_{P} in the second polarization state are reflected by the polarization beam splitter 122A.

Then, the light beams L_{S} are projected to the first phase retarder 123A. After the light beams L_{S} are transmitted through the first phase retarder 123A, the light beams L_{S} are converted into the light beams L₁ in the changed polarization state. Then, the light beams L₁ are projected to the beam splitting element 124A. When the light beams L₁ are projected to the beam splitting element 124A, 50% of the light beams L₁ are transmitted through the beam splitting element 124A and 50% of the light beams L₁ are reflected by the beam splitting element 124A. The portions of the light beams L₁ transmitted through the beam splitting element 124A are projected to the second phase retarder 125B. After the portions of the light beams L₁ are transmitted through the second phase retarder 125B, the polarization state is changed and thus the light beams L₁ are converted into the light beams L_{P} in the second polarization state. Then, the light beams L_{P} are projected to the filtering element 126B.

The portions of the light beams L₁ reflected by the beam splitting element 124A are returned back to the first phase retarder 123A. After the portions of the light beams L₁ are transmitted through the first phase retarder 123A, the polarization state is changed and thus the light beams L₁ are converted into the light beams L_{P} in the second polarization state. The light beams L_{P} are returned back to the polarization beam splitter 122A and reflected by the polarization beam splitter 122A. Then, the light beams L_{P} are projected to the first phase retarder 123A. After the light beams L_{P} are transmitted through the first phase retarder 123A, the light beams L_{P} are converted into the light beams L₂ in the changed polarization state. Then, the light beams L₂ are projected to the beam splitting element 124A. When the light beams L₂ are projected to the beam splitting element 124A, 50% of the light beams L₂ are transmitted through the beam splitting element 124A and 50% of the light beams L₂ are reflected by the beam splitting element 124A. The portions of the light beams L₂ transmitted through the beam splitting element 124A are projected to the second phase retarder 125B. After the portions of the light beams L₂ are transmitted through the second phase retarder 125B, the polarization state is changed and thus the light beams L₂ are converted into the light beams L_{S} in the first polarization state. Then, the light beams L_{S} are projected to the filtering element 126B.

As mentioned above, the filtering element 126B and the polarization beam splitter 122A have the same axial direction. Consequently, when the light beams L_{S} in the first polarization state and the light beams L_{P} in the second polarization state are projected to the filtering element 126B, the light beams L_{P} in the second polarization state are blocked by the filtering element 126B. That is, only the light beams L_{S} in the first polarization state are allowed to pass through the filtering element 126B. After the light beams L_{S} are transmitted through the optical lens 13B, the light beams L_{P} are projected to the human eyes 90.

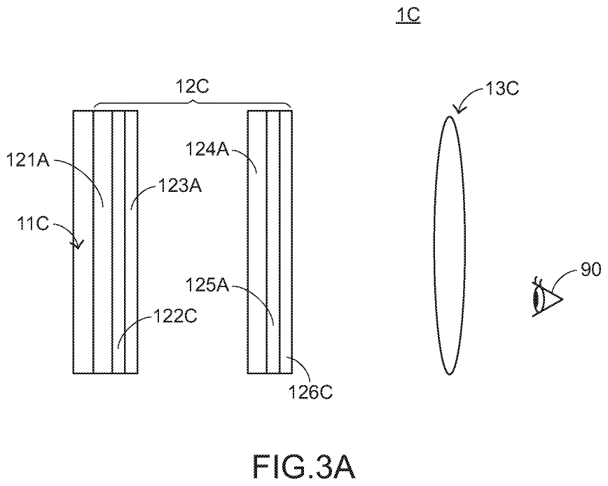

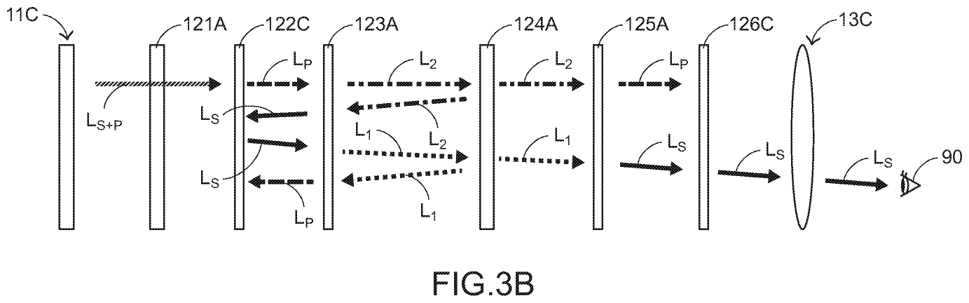

FIG. 3A schematically illustrates the architecture of a head-mounted display and an optical device according to a third embodiment of the present invention. The head-mounted display 1C comprises a display element 11C, an optical device 12C and an optical lens 13C. The optical device 12C comprises a light-transmissible carrier 121A, a polarization beam splitter 122C, a first phase retarder 123A, a beam splitting element 124A, a second phase retarder 125A and a filtering element 126C. The components of the head-mounted display 1C and the optical device 12C which are identical to those of the first embodiment are not redundantly described herein. In comparison with the first embodiment, the light beams in the first polarization state are P-polarized light beams, and the light beams in the second polarization state are S-polarized light beams. That is, only the P-polarized light beams are allowed to pass through the polarization beam splitter 122C, and the S-polarized light beams are reflected by the polarization beam splitter 122C.

FIG. 3B schematically illustrates the optical paths of the head-mounted display and the optical device as shown in FIG. 3A. For clarification, different kinds of light beams as shown in FIG. 3B are indicated by different arrows. In FIG. 3B, L_{S+P} denotes the light beams from the display element 11C, L_{P} denotes the light beams in the first polarization state, L_{S} denotes the light beams in the second polarization state, L₁ denotes the light beams in the changed polarization state, and L₂ denotes the light beams in the changed polarization state. When an image is shown on the display element 11C, the optical device 12C receives the light beams L_{S+P} from the display element 11C. In addition, after the light beams L_{S+P} are transmitted through the light-transmissible carrier 121A, the light beams L_{S+P} are projected to the polarization beam splitter 122C. The light beams L_{P} in the first polarization state are directly transmitted through the polarization beam splitter 122C. The light beams L_{S} in the second polarization state are reflected by the polarization beam splitter 122C.

Then, the light beams L_{P} are projected to the first phase retarder 123A. After the light beams L_{P} are transmitted through the first phase retarder 123A, the light beams L_{P} are converted into the light beams L₂ in the changed polarization state. Then, the light beams L₂ are projected to the beam splitting element 124A. When the light beams L₂ are projected to the beam splitting element 124A, 50% of the light beams L₂ are transmitted through the beam splitting element 124A and 50% of the light beams L₂ are reflected by the beam splitting element 124A. The portions of the light beams L₂ transmitted through the beam splitting element 124A are projected to the second phase retarder 125A. After the portions of the light beams L₂ are transmitted through the second phase retarder 125A, the polarization state is changed and thus the light beams L₂ are converted into the light beams L_{P} in the first polarization state. Then, the light beams L_{P} are projected to the filtering element 126C.

The portions of the light beams L₂ reflected by the beam splitting element 124A are returned back to the first phase retarder 123A. After the portions of the light beams L₂ are transmitted through the first phase retarder 123A, the polarization state is changed and thus the light beams L₂ are converted into the light beams L_{S} in the second polarization state. The light beams L_{S} are returned back to the polarization beam splitter 122C and reflected by the polarization beam splitter 122C. Then, the light beams L_{S} are projected to the first phase retarder 123C. After the light beams L_{P} are transmitted through the first phase retarder 123A, the light beams L_{S} are converted into the light beams L₁ in the changed polarization state. Then, the light beams L₁ are projected to the beam splitting element 124A. When the light beams L₁ are projected to the beam splitting element 124A, 50% of the light beams L₁ are transmitted through the beam splitting element 124A and 50% of the light beams L₁ are reflected by the beam splitting element 124A. The portions of the light beams L₁ transmitted through the beam splitting element 124A are projected to the second phase retarder 125A. After the portions of the light beams L₁ are transmitted through the second phase retarder 125A, the polarization state is changed and thus the light beams L₁ are converted into the light beams L_{S} in the second polarization state. Then, the light beams L_{S} are projected to the filtering element 126C.

In this embodiment, the filtering element 126C and the polarization beam splitter 122C are axially orthogonal to each other. Consequently, when the light beams L_{P} in the first polarization state and the light beams L_{S} in the second polarization state are projected to the filtering element 126C, the light beams L_{P} in the first polarization state are blocked by the filtering element 126C. That is, only the light beams L_{S} in the second polarization state are allowed to pass through the filtering element 126C. After the light beams L_{S} are transmitted through the optical lens 13C, the light beams L_{S} are projected to the human eyes 90.

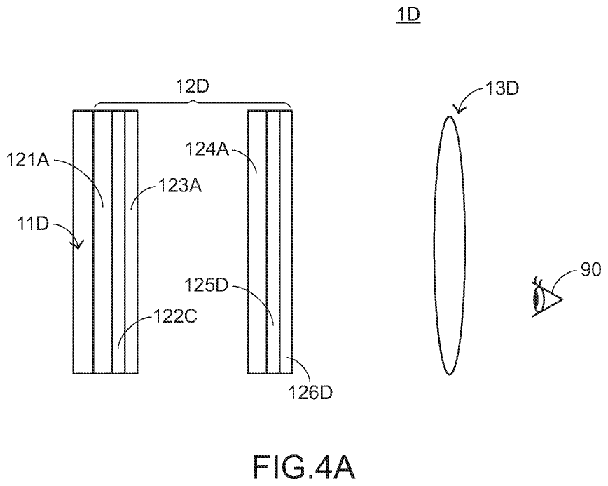

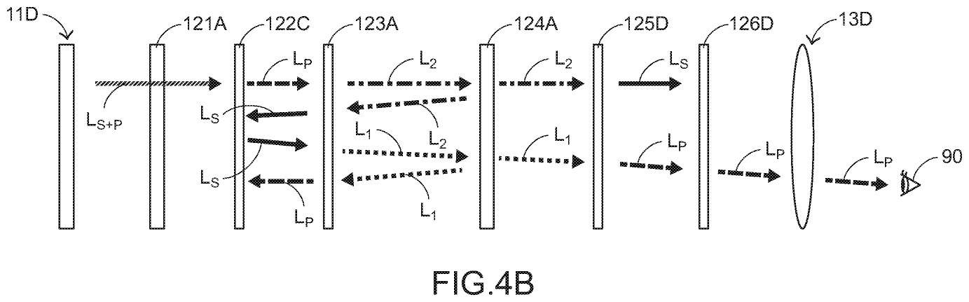

FIG. 4A schematically illustrates the architecture of a head-mounted display and an optical device according to a fourth embodiment of the present invention. The head-mounted display 1D comprises a display element 11D, an optical device 12D and an optical lens 13D. The optical device 12D comprises a light-transmissible carrier 121A, a polarization beam splitter 122C, a first phase retarder 123A, a beam splitting element 124A, a second phase retarder 125D and a filtering element 126D. The components of the head-mounted display 1D and the optical device 12D which are identical to those of the third embodiment are not redundantly described herein. In comparison with the third embodiment, the operation of the second phase retarder 125D is identical to the operation of the first phase retarder 123A. That is, after the light beams are transmitted through the second phase retarder 125D, the polarization state of the light beams is rotated at the first angle in the first direction with respect to the optical axis of the polarization beam splitter 122C. Moreover, the filtering element 126D and the polarization beam splitter 122C have the same axial direction.

FIG. 4B schematically illustrates the optical paths of the head-mounted display and the optical device as shown in FIG. 4A. For clarification, different kinds of light beams as shown in FIG. 4B are indicated by different arrows. In FIG. 4B, L_{S+P} denotes the light beams from the display element 11D, L_{P} denotes the light beams in the first polarization state, L_{S} denotes the light beams in the second polarization state, L₁ denotes the light beams in the changed polarization state, and L₂ denotes the light beams in the changed polarization state. When an image is shown on the display element 11D, the optical device 12D receives the light beams L_{S+P} from the display element 11D. In addition, after the light beams L_{S+P} are transmitted through the light-transmissible carrier 121A, the light beams L_{S+P} are projected to the polarization beam splitter 122C. The light beams L_{P} in the first polarization state are directly transmitted through the polarization beam splitter 122C. The light beams L_{S} in the second polarization state are reflected by the polarization beam splitter 122C.

Then, the light beams L_{P} are projected to the first phase retarder 123A. After the light beams L_{P} are transmitted through the first phase retarder 123A, the light beams L_{P} are converted into the light beams L₂ in the changed polarization state. Then, the light beams L₂ are projected to the beam splitting element 124A. When the light beams L₂ are projected to the beam splitting element 124A, 50% of the light beams L₂ are transmitted through the beam splitting element 124A and 50% of the light beams L₂ are reflected by the beam splitting element 124A. The portions of the light beams L₂ transmitted through the beam splitting element 124A are projected to the second phase retarder 125D. After the portions of the light beams L₂ are transmitted through the second phase retarder 125D, the polarization state is changed and thus the light beams L₂ are converted into the light beams L_{S} in the second polarization state. Then, the light beams L_{S} are projected to the filtering element 126D.

The portions of the light beams L₂ reflected by the beam splitting element 124A are returned back to the first phase retarder 123A. After the portions of the light beams L₂ are transmitted through the first phase retarder 123A, the polarization state is changed and thus the light beams L₂ are converted into the light beams L_{S} in the second polarization state. The light beams L_{S} are returned back to the polarization beam splitter 122C and reflected by the polarization beam splitter 122C. Then, the light beams L_{S} are projected to the first phase retarder 123A. After the light beams L_{S} are transmitted through the first phase retarder 123A, the light beams L_{S} are converted into the light beams L₁ in the changed polarization state. Then, the light beams L₁ are projected to the beam splitting element 124A. When the light beams L₁ are projected to the beam splitting element 124A, 50% of the light beams L₁ are transmitted through the beam splitting element 124A and 50% of the light beams L₁ are reflected by the beam splitting element 124A. The portions of the light beams L₁ transmitted through the beam splitting element 124A are projected to the second phase retarder 125D. After the portions of the light beams L₁ are transmitted through the second phase retarder 125D, the polarization state is changed and thus the light beams L₁ are converted into the light beams L_{P} in the first polarization state. Then, the light beams L_{P} are projected to the filtering element 126D.

As mentioned above, the filtering element 126D and the polarization beam splitter 122C have the same axial direction. Consequently, when the light beams L_{P} in the first polarization state and the light beams L_{S} in the second polarization state are projected to the filtering element 126D, the light beams L_{S} in the second polarization state are blocked by the filtering element 126D. That is, only the light beams L_{P} in the first polarization state are allowed to pass through the filtering element 126D. After the light beams L_{P} are transmitted through the optical lens 13D, the light beams L_{P} are projected to the human eyes 90.

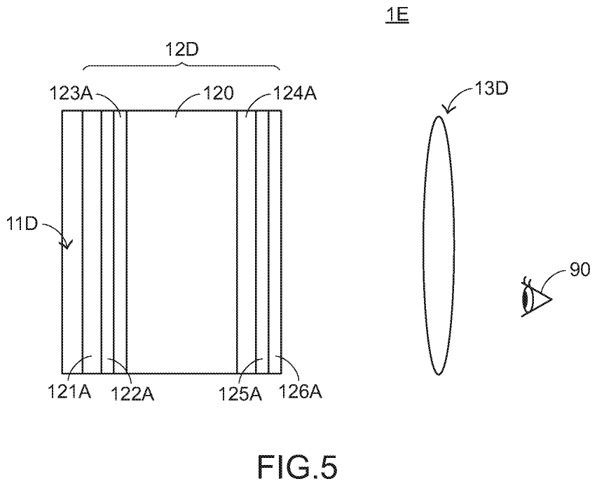

FIG. 5 schematically illustrates the architecture of a head-mounted display and an optical device according to a fifth embodiment of the present invention. The head-mounted display 1E comprises a display element 11E, an optical device 12E and an optical lens 13E. The optical device 12E comprises a light-transmissible carrier 121A, a polarization beam splitter 122A, a first phase retarder 123A, a beam splitting element 124A, a second phase retarder 125A and a filtering element 126A. The components of the head-mounted display 1E and the optical device 12E which are identical to those of the first embodiment are not redundantly described herein.

In comparison with the first embodiment, the optical device 12E is further equipped with a non-air medium 120 between the first phase retarder 123A and the beam splitting element 124A. The light beams are transmissible through the non-air medium 120. Consequently, the optical device 12E is an integral structure. Preferably but not exclusively, the material of the non-air medium 120 is identical to the material of the beam splitting element 124A. Moreover, the non-air medium 120 is integrally formed with the beam splitting element 124A. In this embodiment, the non-air medium 120 is arranged between the first phase retarder 123A and the beam splitting element 124A. This technology is also applied to the optical device 12B of the second embodiment, the optical device 12C of the third embodiment or optical device 12D of the fourth embodiment.

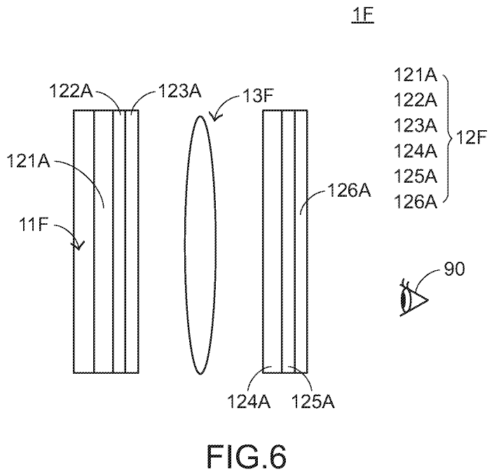

FIG. 6 schematically illustrates the architecture of a head-mounted display and an optical device according to a sixth embodiment of the present invention. The head-mounted display 1F comprises a display element 11F, an optical device 12F and an optical lens 13F. The optical device 12F comprises a light-transmissible carrier 121A, a polarization beam splitter 122A, a first phase retarder 123A, a beam splitting element 124A, a second phase retarder 125A and a filtering element 126A. The components of the head-mounted display 1F and the optical device 12F which are identical to those of the first embodiment are not redundantly described herein.

In comparison with the first embodiment, the optical lens 13F of this embodiment is arranged between the first phase retarder 123A and the beam splitting element 124A. This technology is also applied to the optical device 12B of the second embodiment, the optical device 12C of the third embodiment or optical device 12D of the fourth embodiment.

It is noted that numerous modifications and alterations may be made according to the practical requirements. In case that the demands on the image contrast to be viewed the human eyes are not high, the head-mounted display is not equipped with the filtering element. In case that the demands on the polarization splitting efficiency are not high, a reflective polarizer is used as the polarization beam splitter to replace the dual brightness enhancement film. In another embodiment, the polarization beam splitter and the first phase retarder are non-film hard components. Under this circumstance, the head-mounted display is not necessarily equipped with the light-transmissible carrier to support the polarization beam splitter and the first phase retarder.

In the above embodiments, the light-transmissible carrier, the polarization beam splitter and the first phase retarder are stacked on each other and formed as the first stack structure. Alternatively, the polarization beam splitter and the first phase retarder are separate components. In the above embodiments, the beam splitting element, the second phase retarder and the filtering element are stacked on each other and formed as the second stack structure. Alternatively, the beam splitting element, the second phase retarder and the filtering element are separate components.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. An optical device for a head-mounted display, the head-mounted display comprising a display element and an optical lens, the optical device receiving plural light beams from the display element, wherein along an optical axis of the head-mounted display, the optical device comprises:
a polarization beam splitter, wherein the light beams in a first polarization state are transmitted through the polarization beam splitter, and the light beams in a second polarization state are reflected by the polarization beam splitter;
a first phase retarder, wherein after the light beams are transmitted through the first phase retarder, a polarization state of the light beams is rotated at a first angle in a first direction with respect to an optical axis of the polarization beam splitter;
a beam splitting element, wherein after the light beams are projected to the beam splitting element, first portions of the light beams are transmitted through the beam splitting element and second portions of the light beams are reflected by the beam splitting element; and
a second phase retarder, wherein after the light beams are transmitted through the second phase retarder, the light beams are converted into the light beams in the first polarization state or the light beams in the second polarization state.

2. The optical device according to claim 1, wherein after the light beams are transmitted through the second phase retarder, the polarization state of the light beams is rotated at a second angle in a second direction with respect to the optical axis of the polarization beam splitter, so that the light beams transmitted through the second phase retarder are converted into the light beams in the first polarization state or the light beams in the second polarization state, wherein the second direction is opposed to the first direction, and the second angle is substantially equal to the first angle.

3. The optical device according to claim 2, wherein the optical device further comprises a filtering element, wherein the light beams in the first polarization state and from the second phase retarder are blocked by the filtering element.

4. The optical device according to claim 3, wherein the filtering element and the polarization beam splitter are axially orthogonal to each other.

5. The optical device according to claim 1, wherein after the light beams are transmitted through the second phase retarder, the polarization state of the light beams is rotated at the first angle in the first direction with respect to the optical axis of the polarization beam splitter, so that the light beams transmitted through the second phase retarder are converted into the light beams in the first polarization state or the light beams in the second polarization state.

6. The optical device according to claim 5, wherein the optical device further comprises a filtering element, wherein the light beams in the second polarization state and from the second phase retarder are blocked by the filtering element.

7. The optical device according to claim 6, wherein the filtering element and the polarization beam splitter have the same axial direction.

8. The optical device according to claim 1, wherein the optical device further comprises a light-transmissible carrier between the display element and the polarization beam splitter, wherein the polarization beam splitter and the first phase retarder are thin film layers, and the light-transmissible carrier, the polarization beam splitter and the first phase retarder are combined as a first stack structure.

9. The optical device according to claim 1, wherein the optical device further comprises a filtering element, wherein the light beams transmitted through the second phase retarder are projected to and filtered by the filtering element.

10. The optical device according to claim 9, wherein the second phase retarder and the filtering element are thin film layers, and the beam splitting element, the second phase retarder and the filtering element are combined as a second stack structure.

11. The optical device according to claim 9, wherein the filtering element is a polarizer.

12. The optical device according to claim 1, wherein the optical lens is arranged between the second phase retarder and human eyes, or the optical lens is arranged between the first phase retarder and the beam splitting element.

13. The optical device according to claim 12, wherein the optical lens is a Fresnel lens, a biconvex lens, a plano-convex lens, a concave-convex lens, a biconcave lens, a plano-concave lens or a convex-concave lens.

14. The optical device according to claim 12, wherein there is a spacing distance between the first phase retarder and the beam splitting element, and the spacing distance is related to an equivalent focal length of the optical lens.

15. The optical device according to claim 12, wherein if the optical lens is arranged between the second phase retarder and the human eyes, the optical device satisfies at least one of following conditions: (1) 15 mm≤D1≤25 mm, (2) 25 mm≤EFL≤45 mm and (3) 8.5 mm≤D2≤16.5 mm, wherein D1 is a total length of the optical device and the optical lens, EFL is an effective focal length of the optical lens, and D2 is a spacing distance between the first phase retarder and the beam splitting element.

16. The optical device according to claim 1, wherein the light beams in the first polarization state are S-polarized light beams and the light beams in the second polarization state are P-polarized light beams, or the light beams in the first polarization state are P-polarized light beams and the light beams in the second polarization state are S-polarized light beams.

17. The optical device according to claim 1, wherein the first angle is 45±15 degrees.

18. The optical device according to claim 1, wherein the polarization beam splitter is a dual brightness enhancement film or a reflective polarizer, or the first phase retarder is a quarter-wave plate, or the second phase retarder is a quarter-wave plate, or the reflectivity of the beam splitting element is in a range between 30% and 60%.

19. A head-mounted display, comprising:
a display element;
an optical device receiving plural light beams from the display element, wherein along an optical axis of the head-mounted display, the optical device comprises:
a polarization beam splitter, wherein the light beams in a first polarization state are transmitted through the polarization beam splitter, and the light beams in a second polarization state are reflected by the polarization beam splitter;
a first phase retarder, wherein after the light beams are transmitted through the first phase retarder, a polarization state of the light beams is rotated at a first angle in a first direction with respect to an optical axis of the polarization beam splitter;
a beam splitting element, wherein after the light beams are projected to the beam splitting element, first portions of the light beams are transmitted through the beam splitting element and second portions of the light beams are reflected by the beam splitting element; and
a second phase retarder, wherein after the light beams are transmitted through the second phase retarder, the light beams are converted into the light beams in the first polarization state or the light beams in the second polarization state; and
an optical lens arranged between the second phase retarder and human eyes, or arranged between the first phase retarder and the beam splitting element.

20. The head-mounted display according to claim 19, wherein after the light beams are transmitted through the second phase retarder, the polarization state of the light beams is rotated at a second angle in a second direction with respect to the optical axis of the polarization beam splitter, so that the light beams transmitted through the second phase retarder are converted into the light beams in the first polarization state or the light beams in the second polarization state, wherein the second direction is opposed to the first direction, and the second angle is substantially equal to the first angle.

21. The head-mounted display according to claim 20, wherein the optical device further comprises a filtering element, wherein the light beams in the first polarization state and from the second phase retarder are blocked by the filtering element.

22. The head-mounted display according to claim 21, wherein the filtering element and the polarization beam splitter are axially orthogonal to each other.

23. The head-mounted display according to claim 19, wherein after the light beams are transmitted through the second phase retarder, the polarization state of the light beams is rotated at the first angle in the first direction with respect to the optical axis of the polarization beam splitter, so that the light beams transmitted through the second phase retarder are converted into the light beams in the first polarization state or the light beams in the second polarization state.

24. The head-mounted display according to claim 23, wherein the optical device further comprises a filtering element, wherein the light beams in the second polarization state and from the second phase retarder are blocked by the filtering element.

25. The head-mounted display according to claim 24, wherein the filtering element and the polarization beam splitter have the same axial direction.

26. The head-mounted display according to claim 19, wherein the optical device further comprises a light-transmissible carrier between the display element and the polarization beam splitter, wherein the polarization beam splitter and the first phase retarder are thin film layers, and the light-transmissible carrier, the polarization beam splitter and the first phase retarder are combined as a first stack structure.

27. The head-mounted display according to claim 19, wherein the optical device further comprises a filtering element, wherein the light beams transmitted through the second phase retarder are projected to and filtered by the filtering element.

28. The head-mounted display according to claim 27, wherein the second phase retarder and the filtering element are thin film layers, and the beam splitting element, the second phase retarder and the filtering element are combined as a second stack structure.

29. The head-mounted display according to claim 27, wherein the filtering element is a polarizer.

30. The head-mounted display according to claim 19, wherein there is a spacing distance between the first phase retarder and the beam splitting element, and the spacing distance is related to an equivalent focal length of the optical lens.

31. The head-mounted display according to claim 19, wherein if the optical lens is arranged between the second phase retarder and the human eyes, the optical device satisfies at least one of following conditions: (1) 15 mm≤D1≤25 mm, (2) 25 mm≤EFL≤45 mm and (3) 8.5 mm≤D2≤16.5 mm, wherein D1 is a total length of the optical device and the optical lens, EFL is an effective focal length of the optical lens, and D2 is a spacing distance between the first phase retarder and the beam splitting element.

32. The head-mounted display according to claim 19, wherein the light beams in the first polarization state are S-polarized light beams and the light beams in the second polarization state are P-polarized light beams, or the light beams in the first polarization state are P-polarized light beams and the light beams in the second polarization state are S-polarized light beams.

33. The head-mounted display according to claim 19, wherein the first angle is 45±15 degrees.

34. The head-mounted display according to claim 19, wherein the polarization beam splitter is a dual brightness enhancement film or a reflective polarizer, or the first phase retarder is a quarter-wave plate, or the second phase retarder is a quarter-wave plate, or the reflectivity of the beam splitting element is in a range between 30% and 60%, or the optical lens is a Fresnel lens, a biconvex lens, a plano-convex lens, a concave-convex lens, a biconcave lens, a plano-concave lens or a convex-concave lens.
